(19) United States
(12) Patent Application Publication
(10) Pub. No.: US 2013/0262145 A1
(43) Pub. Date: Oct. 3, 2013

(54) PRESCRIPTION DECISION SUPPORT SYSTEM

(71) Applicants: Ken Brown, Cork (IE); Stephen Byrne, Cork (IE); Denis O'Mahony, Cork (IE); Cormac Sreenan, Cork (IE); Cristin Ryan, Cork (IE); Sean Og Murphy, Cork (IE)

(72) Inventors: Ken Brown, Cork (IE); Stephen Byrne, Cork (IE); Denis O'Mahony, Cork (IE); Cormac Sreenan, Cork (IE); Cristin Ryan, Cork (IE); Sean Og Murphy, Cork (IE)

(21) Appl. No.: 13/819,424

(22) PCT Filed: Aug. 30, 2011
(86) PCT No.: PCT/IE2011/000047

§ 371 Date: Jun. 17, 2013

(30) Foreign Application Priority Data
Aug. 30, 2010 (IE) S2010/0525

(51) Int. Cl. G06F 19/00; G06Q 50/24

(52) U.S. Cl. CPC G06F 19/3456; G06Q 50/24
USPC 705/3

(57) ABSTRACT

This invention relates to a prescription decision support system of the type comprising a set of variables and domains, a first constraint base comprising a plurality of logical statements, an Assess algorithm module and a Consistent algorithm module. The logical statements of the first constraint base specify the combination of disease states and treatments that are present that should not occur in a prescription. The prescription decision support system further comprises a second constraint base comprising a plurality of logical statements, the logical statements specifying the combination of disease states and treatments, which treatments should be present in the prescription. By providing such a system, it is possible for the prescription decision to reason about complex relationships including the presence or absence of treatments, or dosages, or the presence or absence of disease states. Furthermore, the system is responsive to the specific nature of the patient's case history.

### INTRODUCTION

This invention relates to a prescription decision support system.

Inappropriate prescribing is a significant problem facing health services. Inappropriate prescribing encompasses acts of commission in which potentially inappropriate medicines (PIM) are prescribed to a patient and acts of omission where medicines that should be prescribed to a patient are not so prescribed. Unfortunately, this problem is particularly common amongst the elderly in society, due in part to the high morbidity rates in the elderly. Inappropriate prescribing often leads to adverse drug events (ADEs) which in some cases result in hospitalisation of the patient and in the most serious cases result in the death of the patient.

Various screening tools have been developed to obviate the possibility of PIMs being prescribed to patients. One such screening tool is the Beers Criteria which is used by some clinicians when deciding whether or not a medicament is likely to cause the patient to have an ADE. By applying the Beers Criteria, the clinician will determine whether or not the prescription is suitable for the client.

Another tool that has been developed to detect both acts of commission and acts of omission is the so-called STOPP-START tool developed in University College Cork. This Screening Tool of Older Person's Prescriptions (STOPP) and Screening Tool to Alert doctors to Right Treatment (START) has been found to be highly effective in not only determining whether or not a prescription is likely to cause harmful side effects but also to determine whether the patient is being prescribed all of the correct medicaments for their ailments. A thorough description of the STOPP-START screening tool can be found in the documents detailed in the bibliography section at the end of this specification and the entire disclosure of those documents relating to the aspects of the STOPP-START system is incorporated herein by way of reference.

Although effective at detecting inappropriate prescriptions, there is a problem with the known tools in that they are paper based and it takes a significant amount of time to determine whether or not a prescription is inappropriate. Therefore, various attempts have been made to provide a computerised screening tool. However, computerisation of these screening tools, and in particular computerisation of the STOPP-START tool is no trivial task.

One computerised screening tool known in the art is Stockley's drug interactions. The Stockley's system is a very simple system that maintains a list of pairs of names of drugs that should not appear together. A user inputs a list of the drugs in the prescription. The system then compares the input list against the forbidden pairs, and if the system finds two drug names in the input list that match a forbidden pair, it raises a flag. Therefore, this tool simply reacts to the presence of two or more drugs in an input list, and is unable to reason about complex relationships, the absence of drugs, or dosages, or the presence or absence of disease states, and thus the tool cannot respond to the specifics of a patient case history.

Other computerised tools used to facilitate prescription of appropriate treatments are disclosed in EP1,953,659, U.S. Pat. No. 7,010,431 and GB2,462,519.

European Patent Application No. EP1,953,659 describes a method for effecting computer implemented decision-support in prescribing a drug therapy which is implemented using a rules database. In this specification, data relating to a drug and data relating to a patient are entered into the rules database and the database outputs a prescription suitable for the therapy.

U.S. Pat. No. 7,010,431 describes a method for effecting computer implemented decision support in the selection of the drug therapy of patients having a viral disease. This specification describes a method in which there is provided a rules database and in which patient data along with other data is entered into the rules database and the database provides an output of drugs suitable for therapy. The drugs suitable for therapy are displayed in a ranking in accordance with their suitability for indication.

GB Patent Application Publication No. GB2,462,519 describes a locally adaptive decision support targeted at patients. The system including a rules engine that receives patient data and applies a localised rule to that patient data to produce a prescribed treatment.

Although beneficial, there are various problems with many of the known solutions. Generally speaking, the known tools are unable to reason sufficiently about complex relationships, or the absence of drugs, or dosages, or the presence or absence of disease states, and thus the known tools cannot respond to the specifics of a patient case history in the desired manner.

It is an object of the present invention to provide a prescription decision support system that overcomes at least some of the problems with the known offerings.

### STATEMENTS OF INVENTION

According to the invention there is provided a prescription decision support system comprising:
a set of variables and domains, where the variables represent treatments or disease states and dosages, severity and durations;
a first constraint base comprising a plurality of logical statements, where each statement is a logical combination of restrictions on values assigned to a subset of the variables from the set of variables and domains, and which specifies a combination of the presence or absence of a patient disease state and a treatment including at least one treatment that is present which should not occur in a prescription;
an Assess algorithm module comprising an algorithm which takes as input a subset of variables from the set of variables and domains with assigned values representing a patient case history and prescription, and which outputs an assessment of the prescription, highlighting any element of the input which violates a constraint in the first constraint base;
a Consistent algorithm module comprising an algorithm which takes as input a logical statement and an assignment of values to the variables in that statement and which determines whether or not the statement and assignment are consistent.

By having such a prescription decision support system, prescriptions can be assessed almost instantaneously, highlighting exactly those elements of the prescription that are inappropriate. The decision support system can stand alone, or can be integrated into existing prescribing software. Due to the constraint-based representation and algorithm, the decision support system is fast, scalable, and can be updated in a straightforward manner. Each individual constraint can be derived from published validated medical literature, and is logically independent of the other constraints, thus making it simple to add new constraints, update old constraints, or remove or disable old constraints. Importantly, by using a constraint-base, the system can reason about complex relationships and can respond to the specifics of a patient case history.

In one embodiment of the invention there is provided a prescription decision support system comprising:
a second constraint base comprising a plurality of logical statements, where each statement is a logical combination of restrictions on values assigned to a subset of variables from the set of variables and domains, and which specifies a combination of the presence or absence of patient disease states and treatments including at least one treatment that is absent, which absence should not occur in a prescription; and in which
the Assess algorithm module recommends a new treatment implied by a constraint in the second constraint base that is violated by the input, and indicates whether the new treatment violates a constraint in the first constraint base.

By having such a decision support system, the system will advise prescribers of possibly recommended new treatments. Furthermore, any recommendations made are themselves checked to ensure that they do not represent a PIM themselves. Due to the constraint-based representation and algorithm, the decision support system is fast, scalable, and may be updated with relative ease. Each individual constraint can be derived from published validated medical literature, and is logically independent of the other constraints, thus making it simple to add new constraints, update old constraints, or remove or disable old constraints. Furthermore, the system is able to reason about complex relationships including the absence of drugs, or dosages, or the presence or absence of disease states.

In one embodiment of the invention, there is provided a prescription decision support system in which the variables are presented in a hierarchical coding scheme for diseases. A hierarchical scheme enables simpler reasoning about diseases classes.

In one embodiment of the invention there is provided a prescription decision support system in which the variables are presented in a hierarchical coding scheme for treatments. A hierarchical scheme for treatments also enables simpler reasoning about drug (or in other words, treatment) classes.

In one embodiment of the invention there is provided a prescription decision support system in which there is provided an Explode algorithm module operable to expand out the disease or treatment in the hierarchical coding scheme with all possible representations of the disease or treatment and create an updated patient case history and prescription accordingly. By having the Explode algorithm module in conjunction with the hierarchical coding scheme, the Explode algorithm module can expand out each treatment or disease state representation into a conjunction of statements representing all logical equivalents from the coding scheme, all superclasses in the hierarchy and all elements of a combination drug as well as their equivalents and superclass. This will provide a more comprehensive screening tool than was heretofore the case.

In one embodiment of the invention there is provided a prescription decision support system in which the Assess algorithm module contains the Explode algorithm module functionality.

In one embodiment of the invention there is provided a prescription decision support system in which the Consistent algorithm module has means to reason about the hierarchical coding scheme. By providing a Consistent algorithm with means to reason about the hierarchical coding scheme, it will be unnecessary to provide an Explode algorithm as the Consistent algorithm can determine whether there are equivalents or superclasses of a treatment or a disease that should be considered.

In one embodiment of the invention there is provided a prescription decision support system in which the variables are associated with elements of existing coding schemes for treatments and diseases and the Assess algorithm module outputs the assessment of the prescription by referencing the existing coding schemes. The use of existing coding schemes ensures consistency with other clinical IT systems and will allow implementation of the system with other existing systems.

In one embodiment of the invention there is provided a computer implemented method of providing prescription decision support, the method comprising the steps of:
receiving a patient case history and prescription with information regarding a patient's disease state and a treatment;
assigning values to a plurality of variables taken from a set of variables and domains corresponding to variables in the patient case history and prescription;
accessing a first constraint base, the constraint base comprising a plurality of logical statements, where each statement is a logical combination of restrictions on values assigned to a subset of the variables from the set of variables and domains, and which specifies a combination of the presence or absence of a patient disease state and a treatment including at least one treatment that is present which should not occur in a prescription and retrieving a logical statement from the first constraint base relevant to one or more of the variables present in the patient case history and prescription;
passing the logical statement and an assignment of the variables in that statement to a Consistent algorithm module and determining whether or not the logical statement and assignment are consistent; and
outputting an assessment of the prescription, highlighting any element of the prescription which violates a constraint in the first constraint base.

In one embodiment of the invention there is provided a computer implemented method of providing prescription decision support comprising the additional steps of:
accessing a second constraint base, the second constraint base comprising a plurality of logical statements, where each statement is a logical combination of restrictions on values assigned to a subset of variables from the set of variables and domains, and which specifies a combination of the presence or absence of patient disease states and treatments including at least one treatment that is absent, which absence should not occur in a prescription and retrieving a logical statement from the second constraint base relevant to one or more of the variables present in the patient case history and prescription; and
outputting a recommendation of a new treatment implied by a constraint in the second constraint base that is violated by the input.

In one embodiment of the invention there is provided a computer implemented method of providing prescription decision support comprising the additional steps of:
checking whether the recommended new treatment violates a constraint in the first constraint base; and
indicating to a user if the recommended new treatment violates a constraint in the first constraint base.

This is seen as a fast way of providing valid recommendations from the second constraint base. Instead of implementing the problems in the second constraint base as a constraint satisfaction problem where the algorithm modules are required to find values to assign to the variables, constraint checking is used. This is implemented by passing the results of any violated constraints from the second constraint base, namely the recommended treatments, through the first constraint base, effectively performing constraint checking. This will produce a result faster than a constraint satisfaction problem.

In one embodiment of the invention there is provided a computer implemented method of providing prescription decision support in which the variables are presented in a hierarchical coding scheme for diseases.

In one embodiment of the invention there is provided a computer implemented method of providing prescription decision support in which the variables are presented in a hierarchical coding scheme for treatments.

In one embodiment of the invention there is provided a computer implemented method of providing prescription decision support in which the method comprises the additional steps of:
expanding out the disease or treatment in the hierarchical coding scheme with all possible representations of the disease or treatment; and
creating an updated patient case history and prescription accordingly.

In one embodiment of the invention there is provided a computer implemented method of providing prescription decision support in which the constraint logical statements are represented as consisting of all possible variables and constraints on combinations of those variables. By implementing such a method, this significantly simplifies the manner in which the constraint problem can be represented and simplifies reasoning about the absence of a drug or the absence of a condition.

In one embodiment of the invention there is provided a computer program product having program instructions stored thereon which when implemented on a computer perform the method.

### DETAILED DESCRIPTION OF THE INVENTION

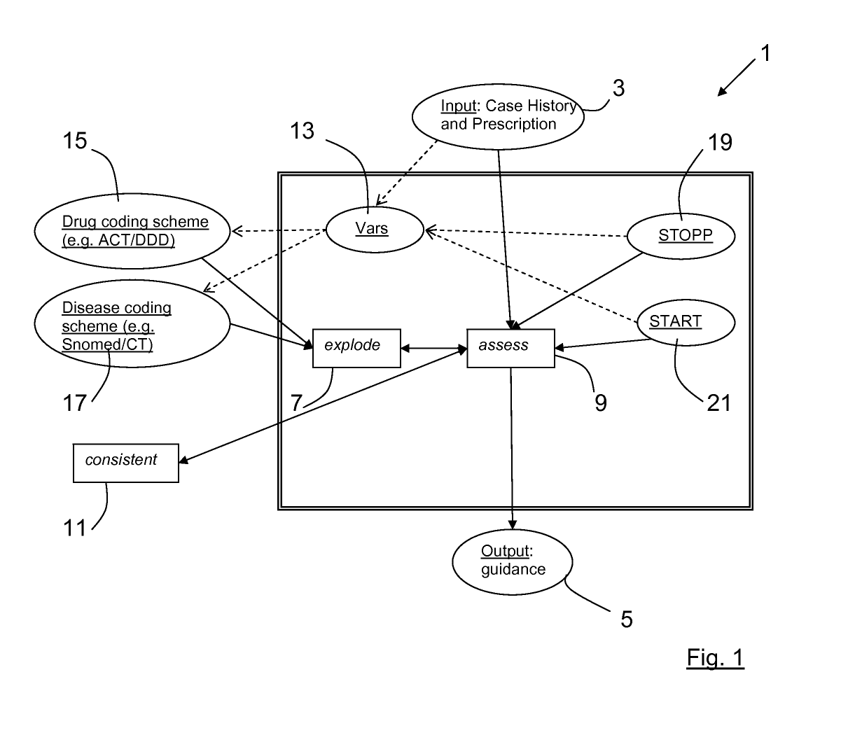

The invention will now be more clearly understood from the following description of some embodiments thereof given by way of example only with reference to the accompanying drawing, in which FIG. 1 is a diagrammatic representation of the components of the prescription decision support system. Referring to the drawing, there is shown a prescription decision support system, indicated generally by the reference numeral 1 comprising an input 3, an output 5, an Explode algorithm module 7, an Assess algorithm module 9 and a Consistent algorithm module 11. The decision support system 1 further comprises a set of variables and domains, (Vars), 13 that has access to a drug coding scheme 15 and a disease coding scheme 17, a first constraint base 19, in this instance called STOPP, and a second constraint base 21, in this instance called START.

The first constraint base 19 STOPP comprises a plurality of logical statements, where each statement is a logical combination of restrictions on values assigned to a subset of the variables from Vars, and which specifies a combination of the presence or absence of patient disease states and treatments, including at least one treatment that is present, which should not occur in a prescription. The second constraint base 21 START comprises a plurality of logical statements, where each statement is a logical combination of restrictions on values assigned to a subset of variables from Vars, and which specifies a combination of the presence or absence of patient disease states and treatments, including at least one treatment that is absent, which absence should not occur in a prescription.

The items in ellipses are static representations of knowledge or data (the coding schemes 13, 15, the constraints 19, 21, the input/output 3, 5 and the set of variables and domains 13. The items in rectangular boxes 7, 9, 11 are algorithms, functions or procedures which take input and produce output. The solid arrows represent the flow of information and calls to algorithms or functions; the dotted arrows show a relationship between knowledge representations. Thus the input data 3 comprising the case history and prescription 3, written as values for variables selected from Vars, representing disease states, severity, durations, and dates, and drugs dosages durations and dates, is passed to the Assess function 9 which in turn calls the Explode function 7. The Explode function 7 reads the coding schemes 15, 17 and produces a new representation of the data. This new representation of the data is then passed back to the Assess algorithm module 9. The Assess algorithm module 9 repeatedly reads constraints from the constraint bases 19, 21, where the variables in the constraints are taken from Vars and from the coding schemes, and calls the Consistent function 11. The Consistent function 11 determines whether or not the constraint has been satisfied and passes back a response to the Assess algorithm module and produces an output 5, in the form of guidance.

In the following example, there is described an application of the prescription decision support system applied to a simplified problem with a limited number of disease variables and a limited number of treatment variables used. It will be understood that this is a simplified version for ease of understanding and that typically, many other disease variables and many other treatment variables will be considered.

The prescription decision support system comprises a set of variables and domains, Vars, in which each variable is associated with an element in the relevant coding schemes. The domains are the range of possible values for each variable. The prescription decision support system further comprises a first constraint base, STOPP, having a first set of a plurality of logical statements, a second constraint base, START, with a second set of a plurality of logical statements, and a module with an algorithm, Assess, which takes as input a set of variables from Vars with assigned values representing a patient case history and prescription, invokes the first and second constraint bases and outputs an assessment and advice on the prescription. The Assess algorithm module uses the Consistent algorithm module which takes as input a logical statement and an assignment of values to the variables in that statement, and which determines correctly whether or not the statement and assignments are consistent. In the embodiment described, the Consistent algorithm module is implemented using the Choco constraint verification algorithm.

It is envisaged that alternatives to the Choco constraint verification algorithm could be used. There are many tools available, including IBM Hog CP Solver, Mozart, ECLiPSe and SICStus constraint library which provide implementations of such algorithms. Alternatively, a Boolean logic satisfiability problem solver, referred to as a SAT solver, could be used once the representation was provided in SAT style.

Table 1 below shows a limited set of STOPP criteria expressed as rules in English. Table 2 below shows a limited set of START criteria expressed as rules in English.

TABLE 1
Example STOPP English-language Rules:

The following drug prescriptions are potentially inappropriate in persons
aged ≧65 years of age:
1. Digoxin at a long-term dose >125 μg/day with impaired renal function*
(increased risk of toxicity).
2. Aspirin with a past history of peptic ulcer disease without histamine H2
receptor antagonist or Proton Pump Inhibitor (risk of bleeding).
3. Non-steroidal anti-inflammatory drug (NSAID) with moderate-severe
hypertension (risk of exacerbation of hypertension).

TABLE 2
Example START English language rules

These medications should be considered for people ≧65 years of age
with the following conditions, where no contraindication to prescription
exists.
4. Aspirin in the presence of chronic atrial fibrillation, where warfarin
is contraindicated, but not aspirin.
5. Angiotensin Converting Enzyme (ACE) inhibitor with chronic heart
failure.
6. Proton Pump Inhibitor with severe gastro-oesophageal acid reflux
disease or peptic stricture requiring dilatation.

As input to the prescription decision support system, there is provided a case history having one or more disease variables and one or more treatment variables. The disease variables are coded in a hierarchical coding scheme. In the example shown, it is only necessary to have a flat structure however when more diseases are to be considered, it is advantageous to structure those disease variables into a hierarchical coding structure. In the present example, the following diseases (with codes) are considered:
IRF—Impaired Renal Function
HPUD—History of Peptic Ulcer Disease
MSH—Moderate-Severe Hypertension
CAF—Chronic Atrial Fibrilation
CHF—Chronic Heart Failure
SGORD—Severe Gastro-Oesophageal acid Reflux Disease
PPSRD—PePtic Stricture Requiring Dilatation
WC—Warfarin Contraindication
AC—Aspirin Contraindication

In this example, the treatments are coded in a simple hierarchical coding scheme. Again, in the present example, it is only necessary to have a mostly flat structure; however when more treatments are to be considered, it is advantageous to structure those treatment variables into a hierarchical coding structure. In the present example, the following treatments (with codes) are considered:
D—Digoxin
A—Aspirin
HHRA—Histamine H2 Receptor Antagonist
PPI—Protein Pump Inhibitor
NSAID—Non-Steroidal Anti-Inflammatory Drug
ACE—Angiotensin Converting Enzyme inhibitor

There is further provided one hierarchical relationship of NSAID-->A. In other words, this hierarchical relationship defines Aspirin as being a Non-Steroidal Anti-Inflammatory Drug.

In the present example, the case history reads as follows:
IRF, WC, [symbol] AC, CAF and MSH,
   and the proposed prescription reads as follows:
D=187.5, A==0, [symbol] PPI, [symbol] HHRA
   where dosages are indicated as values assigned to codes, and drug absences are indicated as either a dosage of 0, or with a “ [symbol] ” symbol in front of the code. In other words, according to the case history, the diseases/conditions of the patient are Impaired Renal Function and a Warfarin contraindication, the patient does not have an Aspirin contraindication but does have Chronic atrial fibrillation and Moderate-severe hypertension. The treatments that the patient is receiving or that it is proposed for the patient to receive are 187.5 μg of Digoxin but no Aspirin, no Protein Pump Inhibitor, and no Histamine H2 receptor antagonist. In the full version of the system, all drugs and all diseases not explicitly stated in the input are set to not present.

The constraints in the STOPP and START constraint bases relevant for this example are shown below in Tables 3 and 4 respectively. Again, it will be understood that this represents only a small section of the available rules that are applied. Each constraint in STOPP has an association with an English language form in Table 1, for output. Each constraint in START has an association with an English language form in Table 2, for output, and an annotation indicating the action that should be taken if the constraint is violated.

TABLE 3
Coded STOPP Rules:

| | |
|---|---|
| #1. [symbol] ([D>125] [symbol] IRF) | [1. (from table 1)] |
| #2. [symbol] ([A>0] [symbol] HPUD [symbol] [symbol] HHRA [symbol] [symbol] PPI) | [2. (from table 1)] |
| #3. [symbol] (NSAID [symbol] MSH) | [3. (from table 1)] |

TABLE 4
Coded START Rules

| | |
|---|---|
| #4. [symbol] (A==0 [symbol] WC [symbol] [symbol] AC [symbol] CAF) | [4. (from table 2); A==75] |
| #5. [symbol] ( [symbol] ACE [symbol] CHF) | [5. (from table 2); ACE] |
| #6. [symbol] ( [symbol] PPI [symbol] SGORD) | [6. (from table 2); PPI] |

The Assess algorithm processes the patient record. In this embodiment, the Assess algorithm 9 first calls the Explode algorithm 7 and the Explode algorithm 7 expands each element of the input into a conjunction of statements, to represent all possible categories and encodings of the disease or treatment in the coding scheme. The expanded conjunction of statements is then passed back to the Assess algorithm. Then, a first constraint base, STOPP (Table 3), is used to analyse the patient record (P). Then, a second constraint base, START (Table 4), is used to analyse the patient record (P). If any of the constraints in the START constraint base are violated, the system returns feedback in the form of a proposed prescription. This feedback is shown in Table 4 in the form of a prescription of 75 mg of Aspirin, ACE and PPI respectively. Once the second constraint base has been considered, the first constraint base, STOPP, is used once again to ensure that no inappropriate prescribing has arisen from the second constraint base stage. The algorithm may be represented as follows:

```
  1. Q := explode(P)
  2. for each constraint c in STOPP
```

| | |
|---|---|
| 3. | if consistent(c , Q) == false |

| | |
|---|---|
| 4. | output the text description of the violated rule |

```
  5. R:= { }
  6. for each constraint c in START
```

| | |
|---|---|
| 7. | if consistent(c, Q) == false |

| | |
|---|---|
| 8. | output the text description of the violated rule |
| 9. | R := R + the drug identified in the rule as being absent |

10. R := explode(R)
11. Q := Q + R
12. for each constraint c in STOPP

| | |
|---|---|
| 13. | if consistent(c, Q) == false |
| 14. | output the text description of the violation |

Line 1 of the algorithm above produces the result Q={D=187.5, A==0, [symbol] PPI, [symbol] HHRA}. The function Explode is intended to replace each original input element with all possible representations of it in the coding scheme. In this example, no elements are expanded. The representation of the patient record is then provided to the plurality of logical statements in the first constraint base.

Lines 2 to 5 implement the STOPP constraint base Criteria and produce an output of the text from rule 1 in table 1, since constraint #1 has been violated (D has a value greater than 125, and IRF is in the case history). However, no other STOPP rules are violated, since HPUD and NSAID are not present in the patient record.

Lines 6 to 8 implement the START constraint base criteria and produce an output of the text from rule 4 in table 2, since constraint #4 has been violated (A has value 0, there is a Warfarin contraindication (WC) present, there is no Aspirin Contraindication (AC) and there is Chronic Atrial Fibrilation (CAF) present in the patients history). No other rules are invoked since CHF is not present and SGORD is not present in the patient record.

Line 9 adds A==75 in to R, the temporary patient record. In other words, 75 mg of Aspirin is proposed to be prescribed due to the violation of constraint #4 above.

Line 10 produces R={A==75, NSAID}, by expansion of the hierarchy. In other words, the proposed prescription of 75 mg of Aspirin and the fact that Aspirin is a Non-Steroidal Anti-Inflammatory Drug (NSAID) are to be added to a temporary patient record for further evaluation. This is achieved by passing the temporary patient record to the Explode algorithm module which identifies that Aspirin is an NSAID and that NSAID is to be added to the temporary patient record for subsequent analysis by the STOPP constraint base.

Line 11 produces Q={D=187.5, A==75, [symbol] PPI, [symbol] HHRA, NSAID}, with the new value of A overwriting the old value for A for the temporary patient record and the Non-Steroidal Anti-Inflammatory Drug aspect of Aspirin being introduced.

Lines 12 to 14 then produce an output of the text from rule 1, since #1 is still violated (D has a value greater than 125, and IRF is in the case history) and the text from rule 3, since constraint #3 is now violated (MSF and NSAID are now both present). Therefore, it can be seen that lines 12 to 14 are implementing the STOPP constraint base criteria once again. Thus the prescription decision support system identified a potentially inappropriate prescription (too high a dosage of Digoxin, encoded in constraint #1), identified a possible omission (omission of aspirin, from constraint #4), and then rechecked the prescription, continuing to identify the Digoxin problem, while also spotting that the recommended addition of Aspirin (which is an NSAID) may exacerbate the hypertension (constraint #3).

In the example shown, there are provided three separate algorithm modules, an Explode algorithm module, an Assess algorithm module and a Consistent algorithm module. It will be understood however that more or less algorithm modules could be used to perform the tasks of these algorithms. For example, the Explode algorithm module and the Assess algorithm module functionality could be combined into a single Assess algorithm module which would perform the functions of the Explode algorithm module as well as the Assess algorithm module. Similarly, the Assess algorithm module and the Consistent algorithm module functionality could also be combined into a single Assess algorithm module which would perform the functions of both the Assess algorithm module and the Consistent algorithm module. Furthermore, the functionality of all three algorithm modules, Assess, Explode and Consistent, could all be combined into a unitary Assess algorithm module that performs the functionality of all three algorithm modules.

The purpose of the Explode algorithm is to facilitate handling of the hierarchical coding schemes. For example, when there is hypertension in the case history and aspirin in the prescription, the coding scheme says aspirin is an NSAID, and there is a constraint saying that NSAID should not be prescribed when the patient has hypertension. The Explode function expands the representation of the prescription so that NSAID is explicitly represented, and then the constraint is activated.

In the embodiment described, the Assess algorithm 9 first calls Explode 7, and then passes the result to Consistent 11. That is because the version of Consistent 11 does not handle hierarchical reasoning, and so Explode 7 is needed. Alternatively, it is envisaged that it would be possible to provide a modified Consistent algorithm 11 that performs hierarchical reasoning. It is envisaged that there are three ways of performing the above tasks: (i) Use an Explode algorithm module to explode the representation (as described above) and then use a standard Consistent algorithm module. In this embodiment, the Assess algorithm 9 has calls to the Explode algorithm 7 embedded inside it. (ii) Write a separate constraint model describing the hierarchy, and then solve this combined constraint model using the known Consistent algorithm 11; or (iii) Use an alternative version of the Consistent algorithm 11 which itself reasons about the hierarchy.

One of the most significant advances of the present invention is that the present invention is implemented using a constraint based system as opposed to being a purely rules based system. The system according to the present invention uses more complex logical statements which specify non-recommended combinations or recommended combinations, including dosages, durations, drug classes and disease classes. In essence, the known systems such as Stockley's can only check statements of the form “not A and B together”, whereas the system according to the present invention can check arbitrary propositional logic statements, including numerical and categorical values. This greatly expands the complexity of information the system according to the present invention can check for over Stockley's system. In addition, the algorithmic application of the constraint checking and hierarchical reasoning in the system according to the present invention allows for checking for omissions, and checking for conflicts in recommendations made by the system.

The use of a constraint based system in this area would be considered to be counter-intuitive for a number of reasons. First of all, medical decision making tends to be fuzzy, with a lot of scope for judgement by the medic, while constraint systems tend to be crisp, and work best on definite yes or no problems or problems where there is a clear mathematical objective function. The approach according to the present invention is to treat the problem as being crisp, and so it flags up all elements of prescription that might be considered inappropriate, and then leave it up to the medic to use their judgement as to whether or not to accept the recommendations.

Another reason why it is considered to be counterintuitive to use constraint based systems to solve the problem tackled by the present invention is that the natural way to think of the problem is to consider the prescription as a variable which must be assigned a list of values (the drugs). Similarly, the patient is a variable that has been assigned a list of values (the diseases). That makes it difficult to represent as a constraint problem. Instead, according to the present invention, the problem is represented as consisting of many variables (e.g. a variable stating whether or not aspirin is present, then a different variable stating whether or not digoxin is present, and so on, and a variable to state whether diabetes is present, and so on. One could consider the hierarchy of drugs in ATC and the hierarchy of diseases in Snomed, gather all the leaf nodes, and there should be a separate variable for each leaf node), and then constraints on combinations of those variables. Using this methodology makes it much easier to represent the constraints, and easier to reason about the absence of a drug or the absence of a condition.

When first approaching the problem, it was also expected that it would be necessary to have to solve the START aspect as a constraint satisfaction problem. That is, it was expected that the algorithms would have to search for values to assign to the variables, which could take a long time to produce an answer. However, a solution to this problem was found by reusing the STOPP aspect of the invention. The STOPP aspect functionality is referred to as constraint checking, which is much faster than solving a constraint satisfaction problem. According to the present invention, the START aspect of the invention has been recast as a similar problem to the STOPP problem and is checked by simply running the constraint checking algorithm again on the START constraints.

Various different coding schemes for the classification of diseases and treatments could be used in conjunction with the present invention. For example, the coding scheme for the classification of treatments could be the hierarchical Anatomical Therapeutic Chemical scheme (ATC). The ATC is maintained by the World Health Organisation. It is envisaged that the coding scheme for the classification of diseases could be the hierarchical Systematized Nomenclature of Medicine—Clinical Terms (Snomed—CT) scheme. The Snomed—CT scheme is maintained by the International Health Terminology Standards Development Organization. Alternatively, the coding scheme for the classification of diseases could be the International Classification of Diseases, 10th edition (ICD-10) scheme, maintained by the World Health Organization or the International Classification of Primary Care, Second edition (ICPC-2) scheme, also maintained by the World Health Organization.

In a further alternative, a custom-built hierarchical coding scheme for the classification of the diseases or a custom-built flat coding scheme for the classification of the diseases could be provided. Similarly, a custom-built flat coding scheme for the classification of the treatments could be provided.

It will be understood that although the present invention has been shown to be particularly useful with the STOPP and START criteria, the present invention is in no way limited to the treatment of the elderly and other criteria and constraint bases that apply to other members of the population, not simply the elderly, are readily envisaged.

It will be understood that the method according to the present invention will be performed largely in software and therefore the present invention extends also to computer programs, on or in a carrier, comprising program instructions for causing a computer to carry out the method. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit.

It will be further evident that the present invention will be performed on more than one (processing) machine and even those parts of the method and system described in relation to a single processor or a single computer or machine may in fact be performed over two, three or more machines with certain parts of the computer-implemented method being performed by one device and other parts of the computer-implemented method being performed by another device. The devices may be part of a LAN, WLAN or could be connected together over a communications network including but not limited to the internet.

Many of the method steps can be performed “in the cloud”, meaning that remotely located processing power may be utilised to process certain method steps of the present invention. It will be further understood that many of the method steps may not be performed in the cloud but could still be performed remotely, by which it is meant that the method steps could be performed either on a separate machine or machines in the same locality or jurisdiction or indeed on a separate machine or machines in one or more remote jurisdictions. Steps performed “in the cloud” may be performed in the same or in a different jurisdiction to the other steps. The present invention and claims are intended to cover those instances where the method is performed across two or more machines located in one or more jurisdictions.

In this specification the terms “comprise, comprises, comprised and comprising” and the terms “include, includes, included and including” are all deemed totally interchangeable and should be afforded the widest possible interpretation.

The invention is in no way limited to the embodiment hereinbefore described but may be varied in both construction and detail within the scope of the specification.

### BIBLIOGRAPHY

P. Gallagher, C. Ryan, S. Byrne, J. Kennedy and D. O'Mahony. “STOPP (Screening Tool of Older Persons’ potentially inappropriate Prescriptions) and START (Screening Tool to Alert doctors to Right i.e. appropriate, indicated Treatment). Validation of new criteria for inappropriate prescribing in the elderly.” International Journal of Clinical Pharmacology and Therapeutics 2008; Vol. 46 No. 2:72-83
Ryan C., O'Mahony D., Kennedy j. and Byrne S. “The use of screening tools to identify potential inappropriate prescribing in the elderly in primary care.” British Pharmaceutical Conference. Manchester—2008, International Journal of Pharmacy Practice 2008, Supp 3, No. 16: C24-25.

C. Ryan, D. O'Mahony, J. Kennedy, P. Weedle, P. Barry, P. Gallagher and S. Byrne. “Appropriate prescribing in the elderly: An investigation of two screening tools, Beers Criteria (Considering Diagnosis (CD) and Independent of Diagnosis (ID) and Improved Prescribing in the Elderly Tool (IPET) to identify inappropriate use of medicines in the elderly in primary care in Ireland.” Journal of Clinical Pharmacy and Therapeutics 2009; Vol. 34, 369-376
S. Byrne, C. Ryan, D. O'Mahony, P. Weedle, J. Kennedy and E. Aherne. “Inappropriate Prescribing in the Elderly: a review of primary care and nursing home prescriptions.” Health Services Research and Pharmacy Practice Annual Meeting. Liverpool 2008. (Oral Presentation) International Journal of Pharmacy Practice 2008; Supp 1 No. 16: A36-37
C. Ryan, D O'Mahony and S. Byrne. “Application of STOPP and START Criteria: Interrater Reliability Among Pharmacists.” The Annals of Pharmacotherapy 2009; Vol. 43
P. Gallagher and D. O'Mahony. “STOPP (Screening Tool of Older Persons' potentially inappropriate Prescriptions): application to acutely ill elderly patients and comparison with Beers' criteria.” Age and Ageing 2008; Vol. 37, 673-679
P. J. Barry, P. Gallagher, C. Ryan and D. O'Mahony “START (screening tool to alert doctors to the right treatment)—an evidence-based screening tool to detect prescribing omissions in elderly patients.” Age and Ageing 2007; Vol 36, 632-638

1. A prescription decision support system comprising:
a set of variables and domains, where the variables represent treatments or disease states and dosages, severity and durations;
a first constraint base comprising a plurality of logical statements, where each statement is a logical combination of restrictions on values assigned to a subset of the variables from the set of variables and domains, and which specifies a combination of the presence or absence of a patient disease state and a treatment including at least one treatment that is present which should not occur in a prescription;
an Assess algorithm module comprising an algorithm which takes as input a subset of variables from the set of variables and domains with assigned values representing a patient case history and prescription, and which outputs an assessment of the prescription, highlighting any element of the input which violates a constraint in the first constraint base;
a Consistent algorithm module comprising an algorithm which takes as input a logical statement and an assignment of values to the variables in that statement and which determines whether or not the statement and assignment are consistent.

2. A prescription decision support system as claimed in claim 1 comprising:
a second constraint base comprising a plurality of logical statements, where each statement is a logical combination of restrictions on values assigned to a subset of variables from the set of variables and domains, and which specifies a combination of the presence or absence of patient disease states and treatments including at least one treatment that is absent, which absence should not occur in a prescription; and in which the Assess algorithm module recommends a new treatment implied by a constraint in the second constraint base that is violated by the input, and indicates whether the new treatment violates a constraint in the first constraint base.

3. A prescription decision support system as claimed in claim 1 in which the variables are presented in a hierarchical coding scheme for diseases.

4. A prescription decision support system as claimed in claim 1 in which the variables are presented in a hierarchical coding scheme for treatments.

5. A prescription decision support system as claimed in claim 3 in which there is provided an Explode algorithm module operable to expand out the disease or treatment in the hierarchical coding scheme with all possible representations of the disease or treatment and create an updated patient case history and prescription accordingly.

6. A prescription decision support system as claimed in claim 5 in which the Assess algorithm module contains the Explode algorithm module functionality.

7. A prescription decision support system as claimed in claim 3 in which the Consistent algorithm module has means to reason about the hierarchical coding scheme.

8. A prescription decision support system as claimed in claim 1 in which the variables are associated with elements of existing coding schemes for treatments and diseases and the Assess algorithm module outputs the assessment of the prescription by referencing the existing coding schemes.

9. A computer implemented method of providing prescription decision support, the method comprising the steps of:
receiving a patient case history and prescription with information regarding a patient's disease state and a treatment;
assigning values to a plurality of variables taken from a set of variables and domains corresponding to variables in the patient case history and prescription;
accessing a first constraint base, the constraint base comprising a plurality of logical statements, where each statement is a logical combination of restrictions on values assigned to a subset of the variables from the set of variables and domains, and which specifies a combination of the presence or absence of a patient disease state and a treatment including at least one treatment that is present which should not occur in a prescription and retrieving a logical statement from the first constraint base relevant to one or more of the variables present in the patient case history and prescription;
passing the logical statement and an assignment of the variables in that statement to a Consistent algorithm module and determining whether or not the logical statement and assignment are consistent; and
outputting an assessment of the prescription, highlighting any element of the prescription which violates a constraint in the first constraint base.

10. A computer implemented method of providing prescription decision support as claimed in claim 9 comprising the additional steps of:
accessing a second constraint base, the second constraint base comprising a plurality of logical statements, where each statement is a logical combination of restrictions on values assigned to a subset of variables from the set of variables and domains, and which specifies a combination of the presence or absence of patient disease states and treatments including at least one treatment that is absent, which absence should not occur in a prescription and retrieving a logical statement from the second constraint base relevant to one or more of the variables present in the patient case history and prescription; and
outputting a recommendation of a new treatment implied by a constraint in the second constraint base that is violated by the input

11. A computer implemented method of providing prescription decision support as claimed in claim 10 comprising the additional steps of:
checking whether the recommended new treatment violates a constraint in the first constraint base; and
indicating to a user if the recommended new treatment violates a constraint in the first constraint base.

12. A computer implemented method of providing prescription decision support as claimed in claim 9 in which the variables are presented in a hierarchical coding scheme for diseases.

13. A computer implemented method of providing prescription decision support as claimed in claim 9 in which the variables are presented in a hierarchical coding scheme for treatments.

14. A computer implemented method of providing prescription decision support as claimed in claim 12 in which the method comprises the additional steps of:
expanding out the disease or treatment in the hierarchical coding scheme with all possible representations of the disease or treatment; and
creating an updated patient case history and prescription accordingly.

15. A computer implemented method of providing prescription decision support as claimed in claim 9 in which the constraint logical statements are represented as consisting of all possible variables and constraints on combinations of those variables.

16. A computer program product having program instructions stored thereon which when implemented on a computer perform the method of claim 9.
